(19) United States
(12) Patent Application Publication
(10) Pub. No.: US 2010/0010873 A1
(43) Pub. Date: Jan. 14, 2010

(54) SYSTEM AND METHOD FOR INFORMATION ACQUISITION AND SHARING

(76) Inventor: Matt Moreau, Denver, CO (US)

Correspondence Address: Jason H. Vick;Sheridan Ross, PC, Suite # 1200, 1560 Broadway, Denver, CO, 80202, US

(21) Appl. No.: 12/499,889

(22) Filed: Jul. 9, 2009

Related U.S. Application Data
(60) Provisional application No. 61/079,209, filed on Jul. 9, 2008.

(51) Int. Cl. G06Q 30/00; G06Q 10/00; G06F 17/30; G06Q 50/00; G06F 15/16; G06F 17/00

(52) U.S. Cl. 705/10; 705/14.36; 705/14.1; 707/3; 705/14.13; 709/204; 235/380; 707/E17.014

(57) ABSTRACT

A business card scanner with software recognition or optical character recognition (or at a network server) that is placed within a business, retail space and/or point of customer contact and typically at the point of customer sale in the particular business. A business card can be requested from a customer by a customer service representative within a business. A free standing automated kiosk, interactive screen, or stand-alone automated inquiry could also request a business card from anyone in the vicinity via inquiry. The configuration of the business card scanner that resides in a kiosk model could be stand alone or be part of a larger modality/device already within a particular business or used in conjunction with other devices in the same space. The inquiry is any type of messaging/communication that results in a business card being inserted by a customer.

### RELATED APPLICATION DATA

This application claims the benefit of and priority under 35 U.S.C. §119(e) to U.S. Patent Application No. 61/079,209, filed Jul. 9, 2008, entitled “System and Method for Information Acquisition and Sharing,” which is incorporated herein by reference in its entirety.

### SUMMARY

An exemplary embodiment of this invention relates to obtaining, networking and organizing customer information via business card scanning at a point-of-sale, a point of customer contact, or within the traffic area of a retail space where the scanned information is networked and the data (fields or content of the business card) is organized into all of the fields present or within a business card. The fields (a field can be any and all data or categories on a business card. It also includes data down to the character level within a category) are parsed/isolated and populated to allow for searches or ‘data mining’ in a customer database of scanned business cards. The searches can be further customized with automation of communication by the particular business to give that business more competitive customer data, a more directed marketing plan, and strategic advantage over their competition for that particular business.

An exemplary embodiment of the invention relates to a business card scanner with software recognition or optical character recognition (or at a network server) that is placed within a business, retail space and/or point of customer contact and typically at the point of customer sale in the particular business. A business card can be requested from a customer by a customer service representative within a business. A free standing automated kiosk, interactive screen, or stand-alone automated inquiry could also request a business card from anyone in the vicinity via inquiry. The configuration of the business card scanner that resides in a kiosk model could be stand alone or be part of a larger modality/device already within a particular business or used in conjunction with other devices in the same space. The inquiry is any type of messaging/communication that results in a business card being inserted by a customer.

In both exemplary situations, the card is requested most often under the understanding of a promotional opportunity or inquiry related to that business or an incentive for a customer to have his/her business card scanned. The business card is then scanned via the device and ‘incentive,’ and typically returned to the customer. The device, or business card scanner, is networked to a server or storage device where the data from the business card is forwarded via a communication protocol and collected and managed for the business. The data is extracted/recognized/parsed from the business card at the server/storage location such that it also identifies the particular location (recognizes and delineates between different geographical locations within the same company brand). One or more of the data fields on a business card are extracted and parsed so that all of the fields are translated and loaded into the different fields present on a business card.

The different fields allow for easy searches based on the fields of a business card such as; Title, Person Name, Zip Code, Area Code, Company Name, web page, Physical (or multiple physical address) and Email Address. The above parsed data output allows for easy data mining and customizable automated searches. The data and manipulation of the data are made available to the subscribers, for example, a business, via hard copy, electronically, internet, or intranet. The above data can be used in accordance with one exemplary embodiment for the purposes of data mining the information for more strategic marketing and a potentially better use of directed marketing dollars. The information that can be mined allows subscribers (the business) to understand their customer's demographic, occupation, and obtain contact information in addition to who they may be missing as a customer. The software allows a particular business to query and isolate any of the parsed fields on a business card. The technology allows for automated mailers, emails, and other marketing campaigns that are designed for the customers that fit a particular search and strategy. For example, the search that generates that email, mailer or marketing campaign may be based on geography, which is at least available via the parsed zip codes from scanned business cards (or based on title, company, etc). The Subscriber is able to use the technology to proactively automate these searches. Examples are further described below.

In summary, data that is parsed, populated, and managed from the server is used to collect valuable marketing information relating to a customer base, potentially across multiple identifiable locations, in any way advantageous to the business/subscriber. The technology entails a small scanner be placed at the Point-of-Sale in a business/retail space, although it could be at point of entry or other point of contact with a customer within the business space (kiosk model). The scanner (in the described configurations) at any of the above locations is then networked to collect data gathered from all locations to be mined by or for the subscriber.

These and other advantages will be apparent from the disclosure of the invention or inventions contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine,” “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, expert system or combination of hardware and software that is capable of performing the functionality associated with that element. Also, while the invention is described in terms of exemplary embodiments, it should be appreciated that individual aspects of the invention can be separately claimed.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 illustrates an exemplary data acquisition system according to this invention;

FIG. 2 illustrates a flowchart illustrating an exemplary method of operation of the data acquisition system according to this invention;

FIG. 3 illustrates an exemplary database architecture according to this invention.

### DETAILED DESCRIPTION

The invention will be described below in relation to a data acquisition environment. Although well suited for use with circuit-switched or packet-switched networks, the invention is not limited to use with any particular type of communications system or configuration of system elements and those skilled in the art will recognize that the disclosed techniques may be used in any application in which it is desirable to acquire data. The exemplary systems and methods of this invention will also be described in relation to software, modules, and associated hardware and network(s). In order to avoid unnecessarily obscuring the present invention, the following description omits well-known structures, components and devices that may be shown in block diagram form, are well known, or are otherwise summarized.

For purposes of explanation, numerous details are set forth in order to provide a thorough understanding of the present invention. It should be appreciated however, that the present invention may be practiced in a variety of ways beyond the specific details set forth herein.

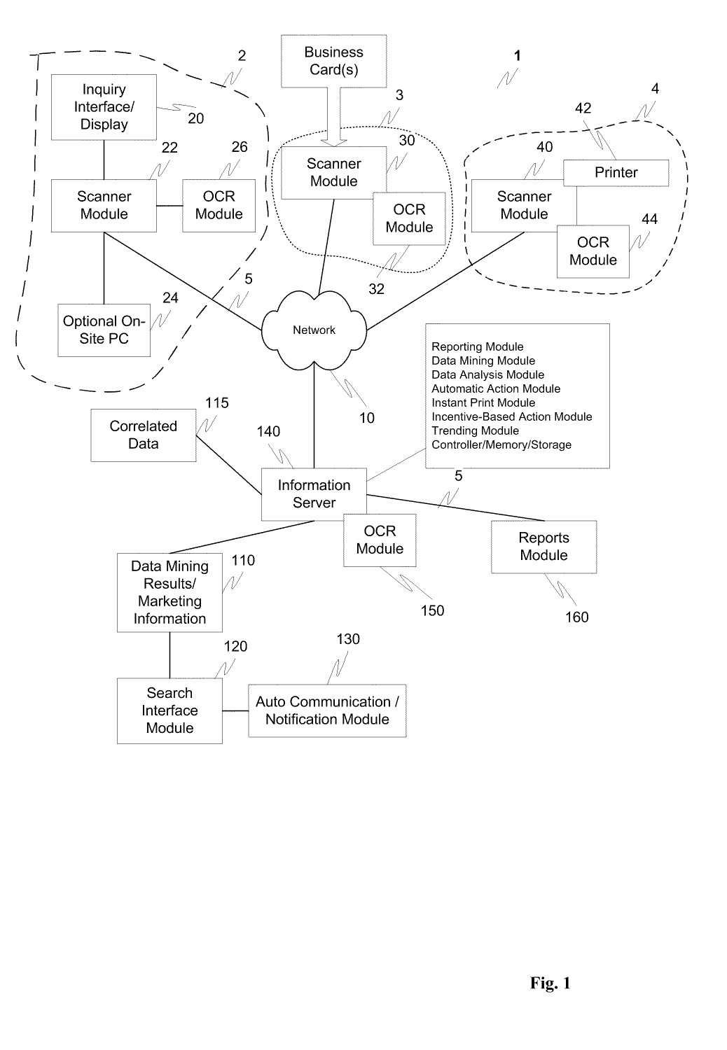

FIG. 1 illustrates an exemplary data acquisition system 1. The data acquisition system 1 includes three data acquisition mechanisms 2-4. Data acquisition mechanism 2 includes an inquiry interface/display 20, a scanner module 22, an optional on-site PC 24 and an OCR module 26. Data acquisition module 3 includes a scanner module 3 and OCR module 32. Data acquisition mechanism 4 includes a scanner module 40, printer 42 and OCR module 44. The data acquisition system 1 further includes an information server that includes reporting module, a data mining module, a data analysis module, an automatic action module, an instant print module, an incentive-based action module, a trending module as well as controller(s), memory and storage, all interconnected via one or more links 5 and network(s) 10. The data acquisition system 1 further comprises an OCR module 150, a reports module 160, data mining results and marketing information 110, a search interface module 120 and an auto communication module 130. Correlated data 115 can also be stored and associated with the data acquisition system 1.

An exemplary generic business card scanner system includes the following:
a) a business card scanning apparatus with OCR or software recognition. This scanner could reside as a stand-alone device or in conjunction with other devices or modalities.
b) a networked cable such as: Ethernet, modem line, wireless device, firewire, USB or other cable or wireless mechanism to transport information.
c) a network hub that accepts data from multiple business card scanning locations via the above.
d) recognition software stored on a computer-readable medium that automates parsing and organizing data to allow field queries.
e) software stored on a computer-readable medium that automates strategic plans after the data has been parsed.

### EXAMPLE 1

One or more scanners reside at a retail point-of-sale within a business, e.g., data acquisition mechanism 3. One scanner module 30 can be at, for example, each of 3 registers or 3 points-of-sale. The scanners are then networked to the customer database (information server 140). Once a card is inserted into a scanner, the information on the card is scanned, recognized, optionally OCRed with the cooperation of OCR module 32, and parsed into the appropriate fields.

### EXAMPLE 2

The scanner may also reside near or in an interactive interface with an optional touch screen that may not reside at the point-of-sale but at a point of customer contact (lobby, near the Point-of-Sale, reception area, entrance, exit, or other customer traffic area). For example, as illustrated in conjunction with data acquisition mechanism 2, the data acquisition mechanism can be a stand-alone scanner that uses the same ‘incentive’ concept or any inquiry but has an interface 20 that delivers the promotion and prompts for the card to be scanned by the scanner module 22. The scanner may use an automatic inquiry with promotion, incentive, or other reason for a customer to insert their business card. The inquiry may also be prompted by signage, touch screen, automated display, customer service guidance, or any mode to communicate the incentive/inquiry to a customer to engage them to insert their business card to be scanned.

As a possible example, after checking in at the hotel a touch screen 20 resides near the lobby. The customer notices that the touch screen states “Register for Free Weekend for 2 and Golf in San Diego” followed by “Insert Business Card to Register.” Upon inserting the card into a scanner module 22, the screen 20 would one or more of confirm whether the card was registered, ask for the card to be re-scanned, prompt for the customer to re-insert card with an error message, or other request based on not capturing all of the data needed. In the event there is signage and no automated screen with the same above promotion and simply a free standing card scanner; a light(s), audible sound, or other feedback/cue could optionally confirm receipt of scanned business card. In the same scenario, a customer service representative within the business may guide the customer to register at the above kiosk. This kiosk may also be a part of an existing modality in a particular business to capture traffic or reduce space. For example, Hotel X has an automated kiosk to check in for flights or check email in lobby. While using this service, a prompt is given to insert card based on any of the described or other customized inquiries. Thus, the described technology and scanner is used in conjunction with existing modalities/devices although the uniqueness remains the same. A printer 42 may accompany the scanner, such as in data acquisition mechanism 3, to print a receipt of the incentive, or in general any information.

Exemplary Methodology

As discussed, the exemplary business card scanner (e.g., scanner module) may reside in a retail space which may be at a register, reception, lobby or traffic area of a business. Additionally, traditional physical scanners (not shown) can also be used in conjunction with a home/office PC in a similar manner. The business card scanner uses incentive, promotion, inquiry, or automated requests to obtain registers/scans of business cards. The scanner uses the above inquiries via a customer service representative at point of sale, customer contact, or stand alone communication (signage, automated interface, in conjunction with other modalities, interactive interface or other communication) to engage customer.

The business card scanner and information can be networked, stored, parsed and managed for the retail location with the cooperation of the information server 140. Other scanners that are networked can be internal to a business to share contact information (contact information from a business card that was also gathered from a ‘meeting’), and can be restricted as to whom has the ability to “share” the information.

The business card is electronically scanned (by the scanner module 22) or ‘beamed’ into the space; i.e., the business card is either scanned or beamed to collect data. Current customer scanning, if done at all, is done via manual input of cards and typically at a later date with the card being retained.

The business card may be given back to the customer after scanning, not kept and entered at a later date, or stored in a collection receptacle (not shown) associated with the data acquisition mechanism.

The business card scanner module can also be used as a frequent customer or rewards program. The data mining feature would identify recurring and redundant business cards to measure the frequency. When the desired frequency determined by the subscriber is achieved, a coupon for the reward is automated. Therefore, in lieu of a typical rewards or customer loyalty system where the subscriber would carry a rewards card of some variation of a ‘swipe card’, the module would allow the subscriber to measure loyalty via a scanned business card (eliminating the need to carry a ‘punch card’ or rewards care of some type). For example, a coffee shop offers the 10th coffee as free. There is a business card scanner 2-4 at the check-out area where the customer inserts their business card. The data mining recognizes redundancies for that particular location (or multiple locations) and automates communication 130 when the desired number of purchases is achieved.

The module and data mining 110 would allow for the real time identification of desired customers for the subscriber. The subscriber would designate the customers they would like ‘real-time’ or enhanced speed of identification by a designated parsed field. The identification of the designated parsed field would result in a notification to the subscriber or the desired auto communication module 130 to the customer. For example, a hotel subscriber would like any card with “Convention Coordinator” to be identified and subsequently notified. This allows the hotel subscriber to proactively engage this customer while they are on property.

Any of the data acquisition mechanisms 2-4 could reside at in the above described locations in one or more businesses such as: restaurants, bars, wine bars, liquor stores, coffee shops, hotels, motels, airports, airplanes, real estate development/sales offices, model homes, homes for sale (to track broker traffic), medical practices or offices, grocery stores, electronic retail, home improvement/hardware stores, spa, gym, salon, clothing, golf course, country clubs, golf club fitting locations, tennis clubs, ski shops, ski resorts, outdoor retail locations (REI), banks, law firms, car other rental locations, inside cab/town car/train/subway, bus or other mode of transportation, within elevators, architecture firms, construction/contractor sales offices, computer stores, mall kiosks, spas, school systems (typically private), trade shows, events, other mobile locations and in general in any area of customer traffic within a business space where customer information via a business card is desired and useful, or in general at any location and even with several scanners at the same location (e.g., a trade show). All of the above locations could use a free standing method of communication of an inquiry or use a person within the business to deliver the inquiry and scan the card (or guide the customer to scan the card).

Once scanned by the scanner module 22, 30, 40, the scanner module 22, 30, 40 parses one or more fields of content or other information available from any business card via recognition and output software to the following level and/or sub-levels of the following (i.e., key words within a title, or search by pre-fix of phone number, or parent company name); name, company name, division of that company name, title, zip code, area code, complete cell phone number/office number, any suffix or characters noting background, training, or education (Dr., JD, MD, PhD, RN, MA, etc), email address, web-address/URL, Company Tag Line, Logo, Fax Number, and/or time and date stamp of when the card was scanned and location of the scanner. The time and date stamp could be used to correlate or ‘mine’ information relative to the business card as discussed hereinafter in relation to the data mining results/marketing information 110. As an example, time of day may be important in a restaurant tracking lunch traffic, or date may be important to a hotel to attract particular ‘title’ or ‘business name.’

The business can access retrospective data and output from customers to delineate between locations, look at trends, redundancies, measure any analytic in the output, and correlate multiple pieces of parsed information (time of week of a particular customer's visit with company represented) with the cooperation of the reports module 160 and information server 140. As an example, Business X requests that the described technology ranks their most common “Company” visitors to their location in 2007. Business X will now use that information to develop strategies for 2008 based on the output of data.

The parsed data may also be correlated and supplement internal data. For example, using data internal to the business to associate dollars spent, where dollars were spent, and on what days, at what time of year. For example, Hotel X allows the scanned technology to integrate with any of their internal hotel records, data or information that is often kept. This would give Hotel X more information on their customer base. As a possible scenario, the dollars associated (how much, where, when, on what) could be mined against any and all of the information on a business card (including time and date stamp). In summary, this technology may supplement any and all data already collected by the hotel and add the output to correlate both databases for a more strategic advantage. Therefore, a subscriber has the ability to use and add/supplement internal data with the parsed information via the business card.

The system can correlate time of year, time of day, and time of day with calendar day to the output that is parsed (time and date stamp). This could be used to time marketing campaigns and the incentive/promotion. Therefore, the system would time the promotion or inquiry with the time of year/day/or week. For example, the business card scanner that resides in a hotel states “Receive coupon for free malt at Joe's Ice Cream Shack (or free ice cream cone at nearby location)”. “Insert business card below to receive coupon.” In this situation, the business card scanner is used in conjunction with a promotion that is a local business where the inquiry was based on the time of day and year (June to August). A printer 42 then prints up the coupon upon successful insertion/scanning of business card. The technology can then automate an email with the cooperation of the auto communication module 110 to “Joe's Ice Cream Shack” in this example, to share information, acknowledge coupon output, and potentially share database activity.

In the above situation, the databases that manage the parsed information can determine and output the best inquiries/promotions based on the previously parsed data with the cooperation of the information server 140. The system can correlate the parsed data to suggest inquires or guide subscriber personnel to use the most impactful or effective inquiries which can be stored as correlated data 115. For example, the database of parsed information shows a consistent ‘business or company name’ being scanned in the second week of November. The company is a “Health, Herbal, and Supplement Company.” With that output of data, the promotion or inquiry used in the second week of November is a “Free Protein Shake with Purchase of Another” (at a neighboring smoothie store). This loading of this promotion for the subscriber can optionally be automated or hosted remotely with static or dynamic content. Similarly, because there may be multiple correlations like the above, the customer could select from multiple promotions/inquiries. As an example of multiple inquiries/promotions, on the automated inquiry or the customer service rep may ask “Would you like to Receive a Coupon for a Free Ice Cream Cone, A buy one get one free protein smoothie, or Register for A Weekend for 2 at any of our Properties.”

A touchscreen, screen interface and/or management interface can also be hosted remotely to adjust the messaging based on desired content.

In the above scenario, a printer 42 can be used in conjunction with the business card scanning method to print coupons or incentive receipts that correspond to the inquiry/promotion. The printer can print unique coupons associated with the promotion. The receipt or coupon may indicate and confirm a properly scanned card with the correct output achieved.

In the above scenario, the server can also automate an emailing of a coupon in conjunction with the business versus printing a coupon at the scanner. In addition, the automated response could also text (fax/email/wirelessly transfer) the coupon based on the desired communication from the business to keep the coupons unique and appeal to the customer.

Parsed or populated information allows for data mining and understanding of current customer and non-customer for the subscriber. The output is drilled down or parsed to every available field of the business card. In addition, it is customizable to parse at a character, word, or collection of characters level by the subscriber with the cooperation of the search interface module 120. Any content on a business card can be customized to be parsed based on initiatives of that subscriber.

The subscriber (business) can receive hard copy files on a periodic basis of the customer data. The subscriber can also receive electronic files or access them via the internet or intranet. The subscriber can further request searches for their ‘marketing’ or other strategic department and that information sent in any one or more of the above ways, down to the described parsed level. As an example, a subscriber calls and asks for the following information and data points to be sent or provided:
1) The most common zip codes visiting their location in August
2) Time and Date of Visits from company “X”
3) The most common customer ‘Company’ redundancy in the data for 2007
4) Any customer with ‘Sales’ in the title and within the 303 area code
5) Anyone entered our location from Weller Fargo or Business “X”? This informs the subscriber if they are missing potential traffic from Weller Fargo or Business “X.”
6) Has anyone traveled from 80209 to visit our location? (this could answer the question as to whether to start or stop marketing efforts)
7) Customer Loyalty Program—In the event that the subscriber would like to create a customer loyalty program, the output at the network recognizes redundancy in business cards. Therefore, for example, if the customer would like to offer a ‘free’ burrito after the purchase of 10; the software would recognize the 10th redundancy and a unique automated (email, mail, fax, text) coupon would be sent. This would eliminate multiple punch cards or a variation of a swipe card.

All of the above and other criteria could be automated outputs customized for that subscriber. For example, Subscriber X always wants the data sent from any customer with M.D. with their name or an 80200 zip code. The system is then automated to generate that database for the subscriber and provide the data real time.

User Experience 1:

Customer Service person at Point-of-Sale would ask the customer if they would like to register for a promotion (or be recognized as repeat customer—‘punch card type of promo’). The customer gives the business card to the representative. The card is quickly scanned by a scanner module and handed back to the customer. The information from that card that is scanned is networked to a customer database specific to that location. All fields of information from the card are parsed into categories. These categories that are now available to be queried based on initiatives of the company or business. The subscriber would have the option to manage the database or pay for the service of data mining. Subscriber's Business locations information can be separate based on location or combined with their like businesses across multiple geographies. In the same way, this technology may be used for all identification mediums that can be scanned (rewards card, drivers license, etc., and in general any carrier of information). Additionally, electronic versions of business cards could be received by a scanner equipped to receive electronic communications. For example, an Electronic Business Card (EBC) could be transmitted from a handheld device, such as a phone, PDA or Blackberry® to a suitably equipped scanner with communication capabilities such as Bluetooth®)

Examples of User Experience 1:

Hotel Customer Service Rep:

Mr. Brown would you like to register for a free weekend for 2 at one of our properties that we are currently giving away each month? It just takes a business card to register.

Mr. Brown:

Yes, here is my business card.

(The card is scanned and given back to the customer)

Restaurant #1:

A clerk checking a person out asks the customer if they would like to register for a free lunch for their office that is given away each month. The customer says “yes” and the card is scanned at the register location.

Restaurant #2:

The same clerk lets the customer know that their 10th sandwich (or visit) is free and that they scan business card to recognize their visit. Their business card is scanned and given back to the customer. The software measures the defined redundancies to mail out (or preferred mode of subscriber automated communication) the above promotions and can thus, track number of visits.

Restaurant #3:

A signage and/or customer service representative delivers an incentive to register for a “Free Lunch for Your Office.” A card is either dropped into a bowl or given to the customer service representative. The business cards are scanned, parsed, and used for subscriber initiatives.

User Experience #2:

Another option is for the scanner to be located in the reception or traffic area as a standalone promotion interface or part of another modality. A similar promotion to the above, request the customer to submit business card based on the incentive. The data is managed in the same manner and the output is parsed the in the same way. This option would involve a small interface at a counter, waiting area, lobby, exit area, entrance, guest room, at a table, or in any area with customer traffic.

Examples:

Hotel #1:

A promotion for 10,000 free Marriott points resides near the concierge area. The signage or interface asks for a business card to register. The guest inserts the card. Confirmation is given that card is correctly scanned. The output is parsed into the database.

Hotel #2:

A Interactive Interface in the lobby of the hotel requests customers to register for a “free night promotion.” A guest walks up to the screen and selects register. The interface asks the customer to insert their business card. The card is scanned and given back to the customer. A printer prints out a receipt of the transaction.

Hotel #3:

The above interface (Hotel #2) shows an inquiry for a “Free Smoothie.” This promotion was run because of previous output measuring and correlating data that determined the effectiveness of this promotion based on time. The customer inserts a business card to receive the promotion. A coupon is printed at the interface to indicate a properly captured card. Upon confirmed scanning, a parsed output is networked noting all of the information on the business card with time and date stamp. Local business may be notified via automated response to acknowledge and/or share customer information. Promotion may be implemented based on the data being shared.

Hotel #4:

Customer is in lobby or business center and is using an internet kiosk. This kiosk also contains a business card scanner. The customer is prompted for free internet service insert business card here. Without business card being scanned there is a charge for the internet. Customer inserts business card in response to the inquiry/incentive. Notification of a correctly scanned card is given and the internet is connected at no charge. Data is parsed and output is created for the subscriber. Subsequently, the subscriber may also request enhanced notification for any ‘CEO’ or ‘President’ in a parsed title category. This allows the subscriber to engage a customer more likely to be empowered to make decisions to partner with the hotel.

Hotel #5

Customer in a lobby is using an automated flight check-in kiosk to print out his boarding pass. While at the kiosk, the interface reads “Enjoy 10% off lunch at The Diner in the Airport,” and ‘Click here to receive coupon.’ A business card is scanned after requested from the ‘Click here’ menu. A coupon is printed in addition to his boarding pass. Hence, the business card scanning and collecting of marketing data can be used in conjunction with another device in a like business.

Coffee shop or Restaurant:

A customer orders an item and pays the clerk. Upon paying, the customer moves to the order ‘pick-up area.’ While at the counter, an interface promotes a free “lunch” or “coffee” for an office. The customer is prompted to register by submitting their business card into the scanner. The data is networked and parsed to the database. This scenario could also be used to track the corresponding desired rewards program by the subscriber.

Coffee shop or Restaurant #2

In the above scenario, subscriber has requested enhanced notification of any 80209 zip codes. After a scanned card with an 80209 zip code is parsed, notification is sent to the subscriber. The subscriber then has additional opportunities to offer an additional incentive, promotion, or desired marketing while that customer is on site.

Car Service:

Business traveler ‘X’ is in the back of a car in route to airport. A screen on the back of the seat requests a business card to receive future discounted business travel rates. Traveler inserts card and a prompt letting the traveler know he will receive an automated email with the above information/promotion. The Car Service may now elect to automate an advertisement for discounted airport pickups in the future.

In the same example, the inquiry can be used to provide updates convenient for the customer and thus, prompting him to insert business card. For example, the same screen states, “Receive Email Updates on Car Arrival Time”. In this method, the inquiry can be used to give the customer more efficiency or information as the incentive.

Example of Data Use from the Output:

The data that is parsed from the business card can at least allow for strategic marketing campaigns. The output from the scanned card could isolate one or more of the following fields. Upon having multiple entries, the subscriber can mine any of the data below to understand their customer. The following exemplary categories can be queried or searched for ‘sub-levels’ or ‘key words’ within each category. For Example, cell phone number could be searched for redundancies in area code and ‘303’ could be searched. As another example, ‘Sales’ can be searched to look at all customer with ‘Sales’ anywhere within their card.

Data Structure: (The following data cells can be customized based on any content on the card and the goals of the subscriber)

| | | | | Office | Zip | | | |
|---|---|---|---|---|---|---|---|---|
| Name | Company | Title | Cell Phone | Number | Code | Email | Address | Company Info |
| Smith, | Bardland | Sales | 303-555- | 303-555- | 80202 | smith@gmail.com | 1000 1st St. | Software |
| John | Software | Agent | 4040 | 9090 | | | Denver, CO | Specialists |

| Education/ | | | | | | |
|---|---|---|---|---|---|---|
| Background | Date | Time | Day | Fax Number | URL | Logo |
| PhD | Jan 2, 2008 | 4:15 EST | Thursday | 303-555-8983 | www.bol.com | BARDLAND |

Associated with the data could also be an identifier of the scanner, the location of the scanner and/or information corresponding to an event where the scanner was installed. For example, if the scanner was rented for a trade show application, the scanner could associate the name of the trade show with the acquired information.

Exemplary Parsing of Data Output Methodology:

Business Card is Scanned and confirmation of correctly scanned card is given to user

The Scanner may give automatic feedback recognizing the card was not correctly scanned or that card has 2 sides. It may also prompt for a ‘re-scan’ because the card was mis-fed. Therefore, there can be real-time feedback on the accuracy of the scanned information or need for further information.

The scanner then uses OCR or Software Recognition to parse the above information with logic used in the technology.

Business Card Logo, web address, Name, Company, Company Info or Tag Line, Title/Position, Email, URL, Time, Date, Day of Week, Fax number, Cell number, Office number, Education/Background, Address (with the ability to accept and delineate multiple addresses on the same card), Zip Code are parsed into searchable and/or indexable categories. These categories can be searched for by keyword or category searches. The technology recognizes any redundancies or measurable analytic in the database. For example,

How many customers were scanned on Thursdays vs. other days of the week?

How many customers were from “Borderland Corporation”?

How many people in the database originated from the 303 area code?

How many Doctors visited our location? (Search is carried out for “MD, PhD, or DO”)

Technology can sort and extrapolate any of the acquired and/or associated data with the logic behind the software recognition/OCR. The technology is then malleable to create searches and automailers based on strategic initiatives of the Subscriber.

Output Usage:

The information server, in cooperation with one or more of the action modules, can generate auto-emailers to participants that have scanned their card or mailers based on key word or category searches

The Customizable Automated Searches can be requested or performed by the subscriber as part of the technology, The Subscriber can input a request for any (but not limited to) any of the below examples that relate to the parsed information. Therefore, the subscriber can modify search initiatives for their particular business by using search criteria to automate information or communication with the customer. This is all driven by the customizable output particular to the subscriber.

As For Examples: A Subscriber requests the automation of the below customized customer searches:

A customized search for “Sales” anywhere within a card generates an auto-communication for a lunch catering promotion for a Subscriber X that owns a restaurant. All customers with ‘Sales’ located in the card are emailed or mailed the promotion automatically. The output has thus, given the subscriber output of the customers most likely to cater lunches. Therefore, the output has given this business a more directed and strategic approach.

A search for 80209 zip codes generates a lunch coupon mailer for all customers that fit into the geography of choice by the subscribers customized search criteria and subsequent auto-communication.

A search for “Thursday” within the time stamp of scanned Customers generates a mailed coupon for a Happy Hour Special on Thursdays for Restaurant X.

A search for “Saturday” gives Hotel X an opportunity to email their potential vacation customers future weekend specials and therefore a directed marketing effort for the Subscriber.

A search for “Convention Coordinator” or “Planner” generates an emailer for a Hotel Subscriber to advertise new conference room space. The subscriber also adds a menu to be faxed to the parsed fax number on the business card when the above criteria is found.

A ‘Company’ search reveals that a local company never visits Restaurant Hotel X. A new marketing plan is now derived to try and engage that potential customer. In the same way, Rental Car Company Y notices that a large corporation has never rented from their agency. A new customer promotion is now coordinated.

The software allows the enhanced notification of identifying a customer of interest to the subscriber so the subscriber may have an opportunity to engage them further with a strategy.

In these examples, one exemplary advantage is that the output usage, automation, and customization of business card content is unique.

Other Exemplary Methodologies:

The scanning methodology with the parsing technology can be used at trade shows or an event in a mobile setting to track customers (with optional printing capabilities). The same parsing would occur and the data can be searched for dates/times of a particular event or trade show and track customers for future events or as means to follow-up. Local subscribers, can prepare for events or trade shows based on the time/date stamp in the database. For example, a mobile scanner is used at the “Las Vegas Auto Show.” The technology can be used at individual subscriber exhibits to track customers while at the convention. The Subscriber can use this data to understand where their customers are coming from and how to reach them after such event. They can send automated emailers, mailers or other communication to their customers. The data will also help them prepare for future events by data-mining the collected data. They will better understand who and who is not their customer at an event. For example, at an “Outdoor Show” in Colorado the technology/methodology is used. After the show, the database shows consistency in customers from Wyoming. This subscriber changes their marketing plan to fit this demographic and attend more events in Wyoming. The parsing also shows many customers from the same company. They elect to send a mailer to all employees of this company.

In the same scenario, a mobile unit can be placed at the same event with a promotion and coupled with a printer. An incentive (10% off Lunch at Bob's Deli) is used to engage customers. The unit can be placed there independent of an exhibitor (or in conjunction with). The data for the show as a whole is then used to sell to exhibitors at the show, or local businesses, or for other marketing purposes. The time and date stamp adds value to market the data in the local area for the next event.

The below are examples of the methodology associated with the output and the data mining that is provided via this technology. The data received from a search of the database is unique because it is customizable and can be automated for the subscriber. Also, the inquiries can be modified by the subscriber to change the initiative or search criteria in a real-time fashion. Thus, a subscriber can change the search criteria (as described below) within the database to shift the customer base it is trying to identify in a potentially real time manner. The examples below represent several of these search scenarios above, but the subscriber has the ability to use similar searches for any parsed information (not limited to the below) and to the smallest character level.

The searches can be subsequently followed with automated communication sent because of the corresponding parsed email, fax number, or physical addresses from the business card. This allows for directive marketing communication efforts in a time sensitive an accurate manner.

The below illustrates an exemplary process and strategy for a subscriber and the subsequent output. The following represents a small subset of the searches possible and the process may be as follows:

Subscriber uses the technology to automate a search similar to one of the following examples. As business cards are scanned and parsed, the search criteria is looked for within all fields. When the searched criteria are identified, a customizable communication can be automatically sent via the parsed contact information.

Possible Examples of Use for the Output:

The ‘Title’ field in Business Card could be customized to search for any of the following

(Title searches allow for word, multiple words, or character queries specific to marketing efforts):

Examples of Title Search:
a) ‘Convention Coordinator’ This customized search identifies potential customers empowered to schedule business meetings on-site, book conference space, and cater in-house meals. The output of parsed data thus allows the subscriber to more directly identify a potentially high profit customer.
b) ‘Software’—Searching for ‘Software’ in the content of a business card may be initiated if there is an Electronics Convention the area. This would allow the subscriber to contact possible customers attending the convention beforehand. The software can also prompt or make a subscriber aware of an upcoming event, convention or trade show. Based on the content of the event, the technology can direct searches to find relevant customers in their database. The software also looks at historical data to notify subscriber of upcoming trends in data that may be related the above event. They may also use this information to partner with local business. This search may also be done to understand who is visiting your business from surrounding software companies.
c) ‘Sales’—A search identifying customers with “Sales” within the business card by a hotel subscriber may use this output to identify promotions more likely specific to a “sales” person. For example, in this scenario the hotel subscriber may look for an opportunity to partner with appropriate restaurant/entertainment partners in their market appealing for sales people to visit. A promotion could be sent to the ‘Sales’ people to announce the partnership and thus, attract ‘sales’ people to the hotel subscriber based on the partnership and value add. The same hotel may also seek and search ‘Sales’ people to market conference room space. A subscriber in the restaurant business may search for ‘Sales’ in the title to email sales people who most commonly cater profitable lunches for the subscriber. In all of these examples a corresponding, customized, and automated communication can be used to contact the identified customer.
d) Any ‘Title’ found in a business card would allow the customer to correlate redundancies in titles and create a breakdown of who their customer is and is not. A particular title redundancy correlated with a date, may indicate with a convention in that space and allow the business to correlate that with the geography and other competitors in the space to reach out to and understand better than their competitors. A title redundancy may also guide a business on what type of customers to spend money on and invest in.

Area Code/Zip Code

The following search of an area code or zip code could allow a subscriber:
a) The ability to understand and populate geographies of their clientele.
b) The ability to understand the geography of business they are not capturing according to geography data points created from the automated or searched output
c) Ability in some circumstances to reach out to customers before they ever leave their geography based on knowing their origination from parsed zip code or area code.
d) Direct Marketing efforts based on Geography consistency or redundancy of current customers or, conversely, the geography where they have opportunities and less redundancy. In both cases, the output helps define the strategy.
e) Partner with other businesses according to geography of customer

One of the outputs, could be a map populated with ‘mined’ zip code data points for a customer base. This would allow geographical plans based on customer mix. It may also indicate where the parameters of their marketing directives should start and stop.

The parsed information would also output and provide information on distance traveled data for all customers, average distance traveled, and most common distance traveled to assist in creating strategy.

This map may be color coded or populated with characters to represent customer base and/or icons representing customers from a common source. The map may have dots representing where customers are coming from, with portions of the map being dynamically selectable. The size of the dots may represent the density of the customer base. Another output may use a color scheme to show customer traffic and intensity. The map can also be produced in conjunction with time, such that a map is produced for a time period selected and automated by the subscriber. The subscriber could also input parameters such that only areas where there is some measure of relative redundancy measured to automate a selected marketing campaign.

In a similar fashion, a calendar, chart, graph or comparable display can be populated to understand the customer traffic over a given time period. The technology can output an entire calendar year of traffic and correlate the traffic to particular incentive.

This example shows a condensed version of the first week in June in customer numbers. This may communicate to the local business that a new strategy for Wednesday (in first week of June) is necessary and that a retention strategy should be used on Sunday. A generated email or other communication may go out to the customers based on the subscriber strategy for these particular days.

| Monday | | | | | | |
|---|---|---|---|---|---|---|
| 6/1/2007 | Tuesday | Wed | Thurs | Friday | Saturday | Sunday |
| 45 | 93 | 14 | 100 | 167 | 210 | 228 |

The subscriber could also receive data that correlates the above to other events in the area. For example, a restaurant with the above data may generate a correlation between traffic and a nearby baseball game. The technology would then generate communication for days or nights where there is a baseball game.

The technology could allow one to enter event dates as search criteria so that the data provided would correlate business traffic with all events important to a particular business. The technology could also notify the subscriber of possible events due to redundancy in the parsed information.

The technology could be used at a University with Student ID cards so that data can be parsed off Student ID Cards. Merchants and local businesses could now use the same methodology to track students and market more efficiently. For example, Campus Book Store can now auto email or mail students specials.

Company Redundancy Search
a) Allows the customer to recognize corporate redundancy and thus loyalty to create an appropriate program
b) Recognizing redundancies (consistent customers) allows for proactive behavior and reaching out to customer base with the above knowledge
c) Recognizing companies in the same competitive space that you are missing because a lack of redundancy in the data creating proactive behavior to capture new business.
d) Increase business and profits by being proactive in the redundancies and less reactive in places the subscriber is missing and has opportunity

The application may also manage all of these described initiatives so that there is an automated marketing output.

The above searches are customizable to maximize the goals of your parsed output many times in an automated fashion that allows the subscriber to modify in a quick manner.

Output Example:

The below is an exemplary output from a scanned business card that is managed internally at the business or networked off-site to a central server to be managed and ‘mined.’ The output is capable of isolating, sorting and organizing any content and/or one or more of the fields within a card, such as a business card. The isolated data gives the user the ability to query any of the fields to search for pertinent information. A non-limiting example of some of the categories or fields that could be searched are; phone number, area code, zip code, title or portions of the title, name, company, city, state, address or any word as a part of the previous search.

The below represents an option of parsed output provided for a subscriber (the blank cells would be populated with additional business card data). In this option, after a business card is scanned at a location, the software recognition parses the below fields for the subscriber (the fields can be customized to fit subscriber's needs) into their database. A subscriber can customize the further parsing of the data and automate that parsing across their particular location in addition to the complete database (multiple locations). A subscriber can organize the database by any of the parsed fields. For example, clicking on ‘Zip Code’ would organize data in order with redundancies. In the same scenario, ‘clicking’ on Company name would organize the entire database based on Company name. The ‘Search’ icon would allow the subscriber to search the database for any key word, words, or characters within the database. In this example, “Technology” is searched and all customers with “technology” in the “Company or Business Name” are filtered to the top. The subscriber could also conduct a search based on criteria that could be found anywhere within the content of the card. In that scenario “technology’ would be inputted in the ‘Search Content” field. The search can be broken down to the character level in a particular search or include a group of words/characters. The below searches can be conducted across a single database location or multiple geographical locations. Locations can be isolated and looked at independently or any sum of the total locations.

Search Field : “Technology” (select field below) Search Content:

| | Company | | | | | | | |
|---|---|---|---|---|---|---|---|---|
| | Business | Company | Title/ | | Mobile | Fax | Office | |
| Name | Name | Description | Position | Email | Number | Number | Number | Zip Code |
| Joe | Kelly | “Technology | Chief | jkell@kelec.com | 720-555- | 720-555- | 720-555- | 80202 |
| Kelly | Electronics | Leader” | Technology | | 4535 | 0098 | 3432 | |
| | | | Officer | | | | | |
| Joe | Kelly | “Technology | Chief | ″ | 720-555- | 720-555- | 720-555- | ″ |
| Kelly | Electronics | Leader” | Technology | | 4535 | 0098 | 3432 | |
| | | | Officer | | | | | |
| Joe | Kelly | “Technology | Chief | ″ | 720-555- | 720-555- | 720-555- | ″ |
| Kelly | Electronics | Leader” | Technology | | 4535 | 0098 | 3432 | |
| | | | Officer | | | | | |

| | | | | Time/Date | Suffix/ |
|---|---|---|---|---|---|
| Name | Address | Logo | URL | Stamp | Education |
| Joe | 1 Main St. | Kelly | www.kelec.com | 3/16/2008 | MBA |
| Kelly | Denver, | | | 2:15 pm | PhD |
| | CO | | | EST | |
| Joe | 1 Main St. | ″ | ″ | 3/16/2008 | MBA |
| Kelly | Denver, | | | 2:15 pm | PhD |
| | CO | | | EST | |
| Joe | 1 Main St. | ″ | ″ | 3/16/2008 | MBA |
| Kelly | Denver, | | | 2:15 pm | PhD |
| | CO | | | EST | |

### Customized Output: (Example)

| Zip Code | Date | Time |
|---|---|---|
| 80202 | Mar. 16, 2008-Mar. 20, 2008 | 12:00 pm-5:00 pm |

The above example of ‘customized output’ allows the subscriber to parse any desired data beyond the initially parsed database. The customized output isolates customers in a separate, supplemental database based on the subscriber's strategy (there can be multiple customized databases created and running in parallel). In this example, the subscriber has input three fields to search for and subsequently identify the customers that meet the criteria within the master database and the customers coming into the master database. The subscriber can automate the output to meet any or all of the criteria to be recognized. In this scenario, the subscriber has automated the system to provide all customers with an 80202 zip code, and that entered the business between the above dates and time. The customized output and parsing can be parsed from the character level to multiple word searches within the master database.

### Automated Communication: Yes

### Medium: Email Content: Attached PDF Automate: Upon Receiving

Continuing to use the above example, the subscriber can now elect to simply view and evaluate the customized output or elect to automate communication with customers that meet the customized criteria. In this example, the subscriber has elected to “auto communicate” with the customer via email (option to select mailer, fax, phone call, etc.). The subscriber has also selected to auto-insert a PDF file to be sent to the customer that meets the criteria and to also send the communication upon receiving/identifying the customer that has met said criteria. The subscriber could have the option to send out the communication to all customers meeting criteria at specified times that meet other strategies or timing initiatives.

In summary, upon accurate scanning of a business card or information card, the parsing of the output is customized to organize any and all content on a business card particular to the subscriber. The customizing can organize any and all locations independently or as a sum of locations. Auto communication can then be automated to a selected customer base based on search criteria input by the needs of the subscriber.

As another example, “Sales” could be queried. All data is queried to isolate customers with “sales” anywhere within their information. The “sales” search here could output and isolate a customer base that could be used to direct marketing efforts. For example, a promotion could now be directed for services that a “sales” person would be interested in (i.e.,—lunch catering specials directed to all sales people).

Another query could be used to correlate a local convention with customers that may be attending. For example, an Electronics Convention is being held in Denver; the above subscriber could query all scanned business cards for “electronics” within the content of their card to contact that customer base first.

All of the collected information from scanned business cards can now be queried internally or this methodology would also provide bound information on a periodic basis of a particular company's database. The service of providing searches for the customer to isolate the directed customers would also be a mechanism to examine the data outside of the periodic bounded information.

The data mining can at least occur via hard copy, electronic copy, on-line access, or internal access to the scanned information.

In conclusion, a networked business card scanning device at a retail location as described above can be used to populate critical demographics and other information contained on a business card. The data can assist in understanding your current customer and non-customer information, engage targeted customers while in your business, create a more efficient rewards program, to give you a competitive advantage and spend marketing dollars more efficiently and automate customizable incentives of the particular subscriber.

Other Exemplary Aspects of the invention

A business card or information card scanner that is not solely used in conjunction with home/office PC to organize data via USB connection. Conventional method and reasoning for the above is to more easily load data from a business card and manage your business/personal contacts.

This scanner can be networked off-site, or at a minimum multiple scanners within one site and then networked. Current methodology in all identified business card scanners have a usb line to one personal computer defining the method to be a hard line and download then subsequent acceptance of the file/scanned information. Current methodology also identifies networking as sharing a database within one physical location for internal use. This device would have a network cable (or wireless connection), or multiple usb inputs collected and then networked that would download via automated program.

The above multiple ‘networked’ locations also allow to delineate between different geographical locations (A restaurant located on 1st street vs. another several miles away). In the same process, the technology allows the separation of data from different brands (Courtyard® by Marriott® vs. JW Marriott® vs. Residence Inn®). Therefore, the above allows data to be evaluated for different geographies and brands or as a sum of all locations

The location of the business card Scanner residing at a retail point of contact or close proximity (typically Point-of-Sale) vs. a personal desk or generic internal office location/kiosk.

The location of a networkable business card scanner in any area with business traffic or at any point of customer contact. The scanner may also be used in the above space separate from a customer service representative. For example, a free-standing kiosk with automated communication displaying the inquiry. Or a scanner as part of an interface that resides in the lobby or near a check out location in a business.

The method of typically using promotional ideas, incentive, inquiry, repeat business recognition, or any other engagement tool to induce business card to be scanned in the retail space. This is unique because the common method for scanning a card is by the individual or business desiring to add a business contact.

The method of a person or point of contact within a business delivering an inquiry (most often a promotion or incentive) to a customer in order to receive their business card to be scanned or guiding them to scan their business card. In this method, a subscriber representative drives the inquiry to receive and scan business card.

The method of an automated system for delivering the same inquiry independent of a person used in conjunction with a business card scanner. The inquiry could be using signage, screen display, interactive display, touch screen, or any other communication to engage a customer to insert their business card into the scanning device.

The method of using software to guide and change the inquiries based on effectiveness due to any criteria. Hence, the software is automated to modify inquiries for effectiveness. As an example, in a digital display used in conjunction with business card scanner, an inquiry is automatically changed during the day to deliver a more effective inquiry (promotion/incentive). The software driving the inquiry based on effectiveness in conjunction with a business card scanner is one unique aspect.

The software and thus, display to the customer that automates the process for the customer to insert and properly scan a business card. In addition, the technology confirming or acknowledging a mis-fed or mis-scanned card in an automated fashion.

The method of hosting inquiries associated with business card scanning remotely and modifying them with dynamic content based on analytics from the data mining.

The method of not keeping a physical copy and but rather, returning the card to the customer. Other methodologies involve keeping the hard copy to later be archived or saved as a file. Current methods also typically involve significant time before information is scanned onto standard computer.

The method of parsing data down to character and sub-level fields. Current methods parse name and basic categories for simple contact management.

The method of parsing/populating information that is used to data mine for marketing purposes by the specific field. Typical information from a Business Card Scanner is used to identify the person and then obtain contact information. Therefore, the method of pulling data from other fields on a business card (outside of the name and other common information) and isolate particular key words, characters or numbers is unique. For example, data mining for all 303 area codes or for any contact with “Director” in their title to fit strategies. Businesses/Subscriber using the output to direct marketing efforts is unique. Therefore, the method for parsing and searching at sub-levels or character levels on a business card (i.e. the ability to search for just the word ‘technology’ within any category is unique). Current technology allows for searches on a personal computer at a category level to locate a contact.

The method of automating search criteria and automating response to the search criteria. For example, Business X requests that all 80209 zip codes are automatically sent an email with information on a new product from Business X. The above request for this automation can be done with an interface available to the subscriber or via request to our company. The interface available to the subscriber would allow that subscriber to change inquiries/promotions/inquiries specific to any location or as a whole and also allow the subscriber to execute search criteria. The search criteria can then be automated to simply collect customers with the specific criteria or also automate a communication to that customer. A screen shot for the above function may look like the below:

Here the subscriber has selected a criteria search for all incoming and/or within the database of scanned business cards in their given network of scanners.

| Category Search | Character Criteria |
|---|---|
| Zip Code | 80209 |
| Phone Number | 303 |
| Anywhere in Content | Sales' |

The subscriber with the above search can then select on the same screen or interface whether to automate a communication to that customer. The content of the communication can be inserted and automated as part of the technology. The subscriber can then select from multiple options of communication (mailer, email, fax, phone call etc.) to deliver the created and inserted communication. The subscriber would also have the ability to manually send communication to the above database.

In this scenario, the subscriber would now receive immediate output data of any cards scanned with the above criteria parameters. In addition, the subscriber could then automate communication and the type of communication to be received by the customer (all in an automated fashion).

Additional Exemplary aspects:

The method of aligning marketing/business strategies as part of pulling the isolated data from above, i.e., zip codes to direct marketing efforts or mailers. In the same way, sending automated emails to the titles in a business card that are particular to a marketing strategy. Therefore, a strategy may be input into the database with an automated driven output given.

The method involved in the type of interaction to obtain business cards you are scanning (they are often unknown customers vs. business cards from a business meeting or personal contact). Therefore, the context in which a customer gives a business card is unique.

The method of a printer accompanying a business card scanner. The printer is connected to the business card scanner and may print receipts or information after a scanned business card. Traditional business card scanners are not available with printer or used in conjunction with a printer.

The method of a business card scanning prompting a subsequent email, text, or communication with a customer.

The method of identifying defined customers ‘real time’ via the software.

The method of downloading multiple cards in a series without individually scanning, downloading, accepting scanned information and entering next card. The described system/method allow for the scanning of multiple cards in succession. The automation of a series of cards in previous works has not been identified. Business Card Scanner's now are set-up for individual card scanning and not designed to accommodate customer traffic and to thus not disrupt the speed of the particular business.

The method of producing a hard copy for our customer of all scanned cards over a period of time from the hub of the networked server, that isolates (parses) queried information allowing the business to develop different marketing strategies. For example, a bound copy for the month of June delineated by ‘company name’ (or other field). In the same way, an electronic copy can be provided.

Similar to the above, allowing for internet or intranet archiving to perform the above process. For example, our subscribers have the ability to search via our web-site all networked locations data in a particular field like ‘company name.’ Again, the method of mining isolated (parsed) searches.

The device may also not reside on the network or use memory space of the particular business location. Current devices all use internal network or personal computer space for each scanner with individual licenses.

There can be multiple scanners networked off-site to the same server, computer or storage device from multiple locations. All other business card scanners are set-up for individual computer use and not multiple scanners representing one location that may be connected with other locations in a like business and manner. (It may also do and achieve the above with an on-site networked method).

The networked scanners for a particular business across multiple locations share searching ability across those locations.

The output of data is gathered, parsed, and used unlike any other method in business.

Technology can be mobile and used at events or trade shows. It may also be used independent of a subscriber as a means to collect data. For example, a mobile scanner with the same described methods of inquiry may reside at an event in a traffic area independent of a particular business.

Technology gives cue or confirmation that card is recognized properly.

Technology can be coupled with a printing device to create a receipt of the incentive/promotion or confirmation that a card was scanned correctly. Technology can also automate a communication to the business where that coupon or promotion can be used. The subscriber may also elect to share the database with such business partner

Technology can proactively search for a parsed category so that it may auto mail or email coupon or incentive after confirmed scan. For example, parsed data base is automated to auto communicate with any customer with an 80209 zip code. Or Hotel X Subscriber may auto email any scanned card to thank them for their stay and/or may confirm their entry into a promotion. With the technology, the above would be automated to happen automatically. Or Hotel X could automate a search to auto-email or contact “Convention Coordinators” with a conference room space update. Hotel X could also auto email all scanned cards to enjoy a complimentary drink or gym use.

Technology may do the above real time or update on given cycles.

The technology can be used to parse other cards with data (rewards cards, driver's license, student ID).

Scanned information can be time, day and date stamped to correlate customer traffic to time.

Automated communication (email, mailers, fax, phone call) technology sends out subscriber information/promotions/or other communication based on a category to the customer.

Triggers in key word searches or criteria can automate the above. There is an interface provided to the subscriber to create and modify the criteria.

Software correlates local events with customer data.

Software populates maps and geographies with customer demographics.

Software populates calendar with traffic. Software can also populate on smaller level (time of day).

Software can notify subscriber of upcoming traffic or event based on previous data with an automated message.

Software correlates inquiry/promotion used with business card scanned and can measure effectiveness.

Software runs promotions based on time, day and date. Inquires/incentives vary based on the effectiveness of a particular promotion. A promotion may change automatically in the same day based on the incentive that is most effective. For example, “10% off Breakfast” may automatically change at 10 am to “Buy one, get one free sandwich” at 10:30 am. An interface to drive this automation can be provided to the subscriber.

Software may alert local businesses that are a partner of the subscriber to also understand the customer traffic. For example, Hotel X's scanner gives notice to local restaurant when a coupon is generated for their business.

Technology can use internal data (for example dollars spent at a hotel that are tracked per guest internally) and supplement with information parsed from the business card. This data can then be used on scanning database to data mine further information.

Additional Exemplary Configurations:

Customer submits Business Card to Customer Service Representative or Kiosk most likely based on promotion or repeat business recognition (10th coffee free type). “Reward or incentive program”

Card is scanned and the scanning takes between 3-5 seconds.

The Business Card Scanner may be stand alone device or part of larger device/modality.

The business card scanner networks scanned information to a remote server that manages the scanned information. It is networked via modem/Ethernet cable, wireless network, Bluetooth device, or other data transmission medium. Different locations are delineated by the IP or other network address that make it unique. The information here is provided on a periodic basis in a hard copy or electronic copy to the customer. It may also be accessed by the customer remotely to query the database. The customer may also inquire for our services in querying the data real time. Part of the services and uniqueness is to provide our customer a strategic plan based on data and technology. The strategies are unique because they are based on this automated isolated/parsed information not available to other businesses. These strategies are also uniquely created because the technology can be automated by requests to recognize trends or any measurable analytic on a business card. These trends and measurable analytics can be customized and modified to adapt to the particular business.

Scanners are all located at the retail space within a business. They are subsequently all networked back to one server (either on site or off-site). Traditional business card scanners are located in personal, work, or common private work space.

These devices could all individually be networked and/or connect to a storage device and then networked.

The scanners could be configured to any of the below to create parsed database:

Via: USB cable, modem, Ethernet, wireless, Bluetooth® beamed information, or any other information transmission medium

In another embodiment interface may be automated and is used in conjunction with an incentive or promotion and used in a traffic area of a business. The incentive may be an electronic interface, signage, or any way to communicate the promotion/incentive.

An information server can be networked to one of the options described above. This is the data repository where the data is parsed and can then be data mined

It should be appreciated that the various functionalities disclosed herein need not be necessarily associated with the described graphical user interface, but an additional custom graphical user interface could be provided that allows the various functionality to be selected and status updated.

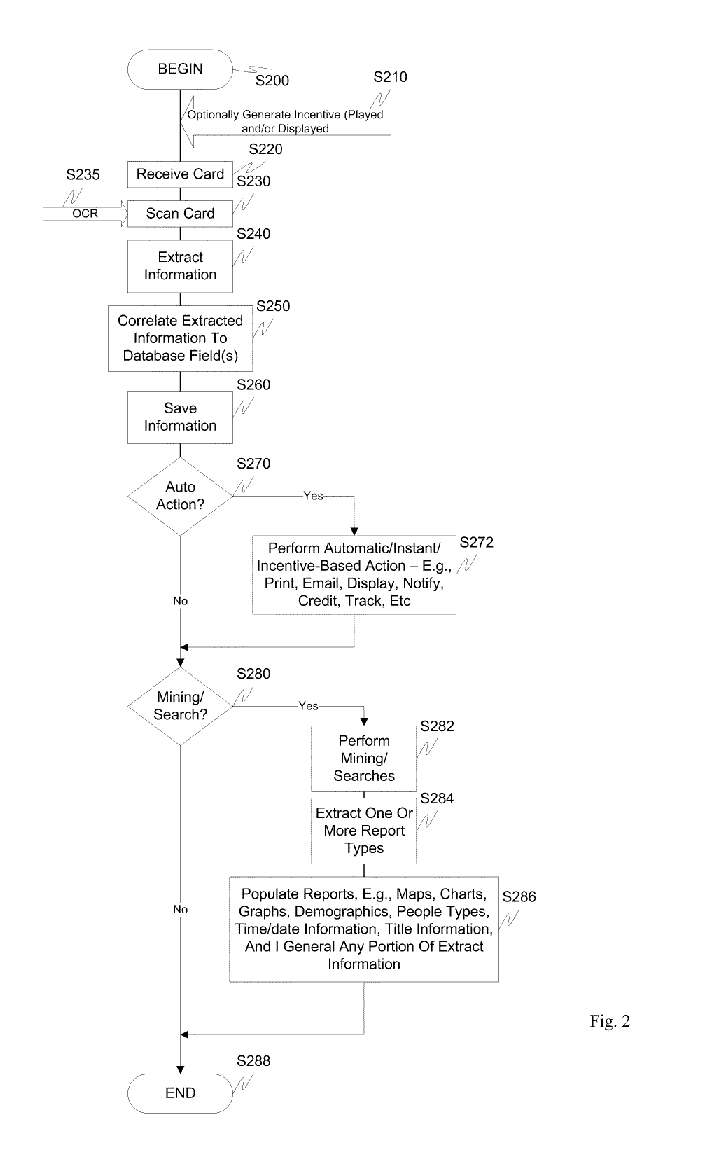

FIG. 2 illustrates an exemplary method of operation of the acquisition system. In particular, control begins in step S200 and continues to step S210. In step S210, an incentive is optionally played and/or displayed to, for example, attract a user to have their card scanned. Next, in step S220, the card is received, and scanned in step S230. In conjunction with the scanning in step S230, OCR (step S235) can be performed to recognize text on the card. Then, in step S240, one or more portions of information are extracted from the card. This information can include one or more of name, title, company, address, phone, zip code, email, logo, prefixes and/or suffixes, and in general any information that can be read and derived from the card. Furthermore, an image of the card can also be stored and, for example, associated with the extracted information. Control then continues to step S250.

In step S250, the extracted information is correlated to one or more database fields. The extracted correlated information is then saved in step S260, for example, in an information server. Control then continues to step S270.

In step S270, a determination is made whether an automatic action should be performed. If an automatic action is to be performed, control continues to step S272. Otherwise, control jumps to step S280.

In step S282, one or more of automatic, instant, and incentive-based actions are taken. These actions can be taken in real-time as soon as a card is scanned, or at some later time. For example, OCR step S235 need not be performed upon immediate scanning of the card. Rather, the OCR can be performed at some later date and time based, for example, on one or more of processing resources, customer demands, business model, business rules, or the like. Examples of the type of action that can be taken are the printing of information, for example on a printer located near the scanner, the emailing of information, displaying of certain information, notification being sent to one or more parties, crediting of a loyalty program based on the scan, tracking of use, or the like, based on the scan, and the like. Control then continues to step S280.

In step S280, a determination is made whether a search for one or more portions of information, or data mining is desired. If one or the other is desired, control continues to step S282. Otherwise, control jumps to step S288 where the control sequence ends.

In step S282, an appropriate interface is provided that allows a user to one or more of perform searches, and data mining of one or more portions of the saved information. This information can be extracted in step S284 with the selection of one or more report types. Then, in step S286, the various desired reports are populated and output. For example, examples of the types of report that can be run include one or more of maps, charts, graphs, demographics, people types, time/date information, title information, and in general can summarize any information of any portion of the extracted information from the input cards. Control then continues to step S288 where the control sequence ends.

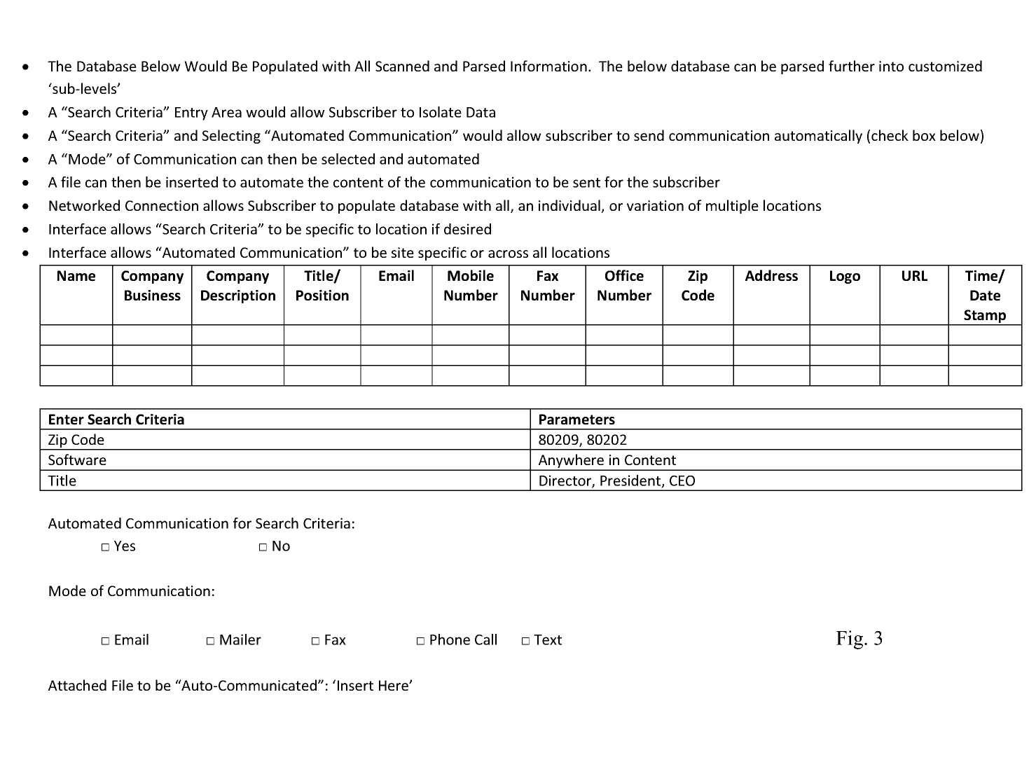

FIG. 3 illustrates an exemplary database architecture according to this invention. The exemplary database (an corresponding user interface) shows exemplary search criteria, parameters and whether an automatic communication is desired. If an automatic communication is desired, selection boxes are provided that allow the selection of the one or modes of communication. The interface also allows the addition of one or more files to be associated with the selection of an auto communication.

A number of variations and modifications of the invention can be used. It would be possible to provide for some features of the invention without providing others.

The exemplary systems and methods of this invention have been described in relation to information management. However, to avoid unnecessarily obscuring the present invention, the description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments illustrated herein show various components of the system collocated, certain components of the system can be located remotely, at distant portions of a distributed network 10, such as a LAN, cable network, and/or the Internet, or within a dedicated system. Thus, it should be appreciated, that the components of the system can be combined in to one or more devices, such as an information management system, or collocated on a particular node of a distributed network, such as an analog and/or digital communications network, a packet-switch network, a circuit-switched network or a cable network.

It will be appreciated from the preceding description, and for reasons of computational efficiency, that the components of the system can be arranged at any location within a distributed network of components without affecting the operation of the system. For example, the various components can be located in one or more of the information management system and information delivery system. Similarly, one or more functional portions of the system could be distributed between a communications device(s), such as a PDA, and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the various methodologies have been discussed and illustrated in relation to a particular sequence of events, it should be appreciated that changes, additions, and omissions to this sequence can occur without materially affecting the operation of the invention.

In yet another embodiment, the systems and methods of this invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, scanners, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a computer-readable storage medium, executed on programmed general-purpose computer with the cooperation of a controller and memory, a special purpose computer, a microprocessor, or the like. In these instances, the systems and methods of this invention can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method for information acquisition and sharing in a customer loyalty environment comprising:
receiving, by a scanner module, an information carrying card;
scanning the card;
extracting, via optical character recognition, one or more portions of information from the card;
correlating and storing the one or more portions of information in a database; and
one or more of determining an action and analyzing the one or more portions of information for customer loyalty tracking.

2. The method of claim 1, wherein the information carrying card is one or more of a business card, rewards card, driver's license, student ID and an ID card.

3. The method of claim 1, further comprising printing a coupon as a result of the determining an action step.

4. The method of claim 1, further comprising updating a customer loyalty field based on the scanning step.

5. The method of claim 1, further comprising generating one or more reports based on the stored one or more portions of information.

6. The method of claim 1, further comprising providing a search interface to search the one or more portions of information.

7. The method of claim 1, further comprising performing an incentive-based action based on the analysis.

8. The method of claim 1, further comprising establishing trending reports based on the one or more portions of data.

9. The method of claim 1, further comprising locating one or more of the scanner modules at one or more of a businesses, restaurant, bar, wine bar, store, liquor store, coffee shop, hotel, motel, airport, airplane, real estate development office, sales office, model homes, homes for sale, medical practice, office, grocery store, electronic retail, home improvement store, hardware store, spa, gym, salon, clothing store, golf course, country club, golf club fitting location, tennis club, ski shop, ski resort, outdoor retail location, bank, law firm, car rental location, a cab, a town car, a train, a subway, a bus, public transportation, in elevators, architecture firm, construction or contractor sales office, computer store, mall kiosk, school system, trade show, event, mobile location.

10. One or more means for performing the steps of claim 1.

11. A computer-readable storage media having instructions stored thereon, that when executed by a processor, perform the steps of claim 1.

12. A system for information acquisition and sharing in a customer loyalty environment comprising:
receiving, by a scanner module, an information carrying card;
scanning the card;
extracting, via optical character recognition, one or more portions of information from the card;
correlating and storing the one or more portions of information in a database; and one or more of determining an action and analyzing the one or more portions of information for customer loyalty tracking.

13. The system of claim 1, wherein the information carrying card is one or more of a business card, rewards card, driver's license, student ID and an ID card.

14. The system of claim 1, further comprising a printer that prints a coupon as a result of the determining an action step.

15. The system of claim 1, further comprising a customer loyalty field that is updated based on the scanning step.

16. The system of claim 1, wherein one or more reports are generated based on the stored one or more portions of information.

17. The system of claim 1, further comprising a search interface to search the one or more portions of information.

18. The system of claim 1, wherein an incentive-based action is performed based on the analysis.

19. The system of claim 1, wherein trending reports are established based on the one or more portions of data.

20. The system of claim 1, wherein one or more of the scanner modules are located at one or more of a businesses, restaurant, bar, wine bar, store, liquor store, coffee shop, hotel, motel, airport, airplane, real estate development office, sales office, model homes, homes for sale, medical practice, office, grocery store, electronic retail, home improvement store, hardware store, spa, gym, salon, clothing store, golf course, country club, golf club fitting location, tennis club, ski shop, ski resort, outdoor retail location, bank, law firm, car rental location, a cab, a town car, a train, a subway, a bus, public transportation, in elevators, architecture firm, construction or contractor sales office, computer store, mall kiosk, school system, trade show, event, mobile location.

21. The method of claim 1, further comprising notifying the subscriber where a previously defined parsed field is identified as pertinent by the subscriber in a scanned card.

22. The system of claim 12, wherein a reporting module notifies the subscriber where a previously defined parsed field is identified as pertinent by the subscriber in a scanned card followed by a subsequent alert.

23. The method of claim 1, wherein content on a display interface displays dynamic content defined by a subscriber and identified effective messaging, based on measured and data mined metrics.

24. The system of claim 12, further comprising displaying dynamic content defined by a subscriber and identified effective messaging, based on measured and data mined metrics.

25. The method of claim 1, wherein customer loyalty and a designed rewards program is measured via the scanner module.

26. The system of claim 12, further comprising a customer loyalty or rewards program measured via the scanner module.
